(19) United States
(12) Patent Application Publication
(10) Pub. No.: US 2011/0008602 A1
(43) Pub. Date: Jan. 13, 2011

(54) Method of Giving an Article a Colored Appearance and an Article Having a Colored Appearance

(75) Inventor: Paul Peeters, Eindhoven (NL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hauzer Techno Coating BV

(21) Appl. No.: 12/810,497

(22) PCT Filed: Dec. 24, 2008
(86) PCT No.: PCT/EP08/11117

§ 371 Date: Sep. 15, 2010

(30) Foreign Application Priority Data
Dec. 28, 2007 (GB) 0725259.6

(51) Int. Cl. B05D 5/06

(52) U.S. Cl. 428/220; 427/164

(57) ABSTRACT

A method of giving an article a colored appearance on at least one external surface thereof when illuminated by light, the method comprising the steps of depositing a transparent coating on said external surface and incorporating a plurality of dispersed particles within the transparent coating, said particles being selected to generate a selectable color or hue by surface plasmon resonance. The coating is preferably designed to suppress interference effects. Also claimed are articles provided with a colored appearance and an apparatus operating a PVD or CVD process for giving articles a colored appearance. The transparent coating can be made hard and wear resistant.

The present invention relates to a method of giving an article a coloured appearance and to an article having a coloured appearance.

Methods of giving articles a coloured appearance are well known. For example articles are frequently painted to endow them, with a specific colour. The coloured paint that is used is frequently comprised of colour giving pigments dispersed in a binder such as a resin binder, e.g. paints that are used to finish the bodies of motor cars. Sometimes the paint provides a coloured but matt finish and a transparent top coat is then used to convert the matt colour to a glossy finish. Such paints are again frequently used for motor car bodies. Fabrics are generally coloured by dispersing a pigment throughout the filaments, fibres or yarns used to weave the fabric or by the use of dyes to colour the filaments, fibres or yarns.

The concept of colour as viewed by an observer essentially means, with regard to a non-self luminous article, that the article is illuminated by visible light, typically visible light having wavelengths extending over a wide range of the optical spectrum, which extends from about 380 nm (blue end) to 700 nm (red end), with the article or its painted (coloured) surface absorbing some wavelengths but reflecting or scattering others. It is the reflected or scattered light which determines the colour of the article as perceived by the viewer.

Some metals, typically aluminium can be given a coloured appearance by anodizing them. Such anodized surfaces also have the advantage that the surface finish is very hard and does not therefore wear easily. Although paints can provide a relatively tough surface such surfaces are prone to wear in use.

Another way of giving articles a coloured appearance is to plate them, e.g. with gold. However, the gold is relatively soft and there is a significant danger that the gold plating will be worn away in use. To overcome this problem it is known to coat the article with a TiN coating by a PVD (physical vapour deposition) process and then to coat it with a thin layer of gold. The TiN coating can be matched very closely to the colour of the gold, so that, if the gold wears away locally the hard TiN coating is reached but does not reveal the fact that the gold has worn away because it has the same colour. Moreover, the TiN coating is very hard so that it is very resistant to wear.

It is also known to coat architectural furniture such as door handles with coatings deposited using a PVD process, so that the corresponding articles are coloured and resistant to wear. Typical colours produced in this way are silver, gold, brown and black.

Another example of coloured articles are stained glass windows. Such windows were already in use in the Middle Ages and it is now known that these were often fabricated by incorporating metallic nanoparticles which give rise to so called surface plasmon resonance in the presence of illuminating light in the optical wavelength range, even if this was not appreciated at the time. This is described in a lecture number 18 apparently given in spring of 2007 at the Oregon State University with the title “Free electron metals: magnetic and optical response” which also describes that such plasmon resonant nanoparticles can be used as biomarkers.

The object of the present invention is to provide a method of giving an article a coloured appearance and an article having a coloured appearance in a new way with the coloured appearance being highly durable and also to provide novel apparatus for carrying out the method and for giving an article a coloured appearance.

Another object of the present invention is to obtain uniform colours without a significant loss of brightness.

In order to satisfy these objects there is provided a method of giving an article a coloured appearance on at least one external surface thereof when illuminated by light, the method comprising the following steps:
depositing a transparent coating on said external surface and
incorporating a plurality of dispersed particles within the transparent coating, said particles being selected to generate a selectable colour or hue by surface plasmon resonance.

Thus the present invention also exploits the phenomenon of surface plasmon resonance but does so not with transparent articles such as panes of stained glass but with a transparent coating on an otherwise opaque or reflecting article.

The step of depositing a transparent coating preferably comprises the use of a PVD (physical vapour deposition) process or of a CVD (chemical vapour deposition process). Such processes enable the thickness of the transparent layer that is deposited to be carefully controlled and kept relatively thin so that the material requirement is minimised.

The transparent coating is preferably selected from the group comprising SiO, SiCₓO_{y}, SiNₓ, SiOₓN_{y}, SiOₓC_{y}N_{z}, C, Al₂O₃, TiO₂, Cr₂O₃, SiOₓ, ZrOₓ and combinations thereof. Such coatings are typically hard and wear resistant and lend themselves to deposition by PVD and CVD processes such as reactive sputtering and plasma enhanced CVD. Accordingly, articles coated with such a transparent layer have a very tough and durable coating.

The said particles consist of at least one of gold, silver, copper, platinum and other metals and it is very favourable that these particles can also be deposited by a PVD process, so that the deposition of the transparent coating and the particles can be carried out in one plant, typically a PVD sputtering plant or a combined PVD/CVD plant. Thus the particles can be incorporated in the transparent coating using a PVD or CVD process.

According to a particularly preferred embodiment of the invention the thickness of said transparent coating is selected to suppress interference effects arising from interference of the illuminating light reflected at the free surface of said coating with illuminating light reflected at an interface of the coating with the article or with another layer of the coating. This prevents such interference effects detracting from the vibrant coloured appearance of the article.

Such interference suppression can be achieved in different ways. In one variant of the invention the transparent coating is given a thickness significantly smaller than the wavelength of the illuminating light. This means that the thickness of the coating is selected so that the phase difference between the illuminating light reflected at the free surface of said coating and the illuminating light reflected at an interface of the coating with the article is kept to a value sufficiently small that interference cannot arise. Bearing in mind that the illuminating light preferably has a wavelength in the optical range from 380 to 700 nm and can cover this range, which is typical for daylight and for some lighting systems that try to emulate daylight, this means that a coating having a thickness of say less that 50 nm for example should not generate any interference.

In another variant of the invention said transparent coating is given a thickness greater than the coherence length λ_{c} of the illuminating light. For light sources the concept of the coherence length refers to the length of each wave packet having a number of waves with the same phase position. The illuminating light will comprise a large number of such wave packets; however, with a non-coherent light source such as a fluorescent lamp, there is a completely random association between the waves of individual wave packets so that no discrete interference minima and maxima can arise. Although the waves of a wave packet can interfere with one another, for example giving rise to phenomena such as Newton's rings, if the coating is made with a thickness greater than λ_{c}/2, then the waves of any one packet cannot interfere with other waves of the same packet and again no interference can arise. That is to say the thickness of the coating can be selected in accordance with the invention to ensure that the light reflected at the coating surface and the light reflected from the substrate surface are incoherent. Since the coherence length λ_{c} for many light sources is rather short only small thicknesses of the transparent coating are required to prevent interference arising as described above. Interference within the transparent coating can however be exploited to improve the coloured appearance of an article. E.g. if the transparent coating is given a thickness having a nominal value in the range 80 to 120 nm especially of around 100 nm it can act to enhance a blue colour by constructive interference (also depending on the refractive index of the transparent coating).

In accordance with the invention the particles can be dispersed in said transparent coating substantially throughout the transparent coating, in particular with a substantially uniform density. If this technique is adopted the density of the dispensed particles within the transparent coating in terms of the number of particles per unit volume of transparent material should be kept relatively low to avoid too much attenuation of the incident illuminating light, which would otherwise tend to be lost in the transparent coating.

Alternatively, and also in accordance with the present invention, the particles can be dispersed in said transparent coating in a stratum thereof and can then have a relatively higher density in terms of the number of particles per unit volume of transparent material.

In one variant of the invention the transparent coating comprises at least first and second layers and said stratum comprises one of said layers, said first and second layers preferably having identical refractive indices.

The article may also be coated, in accordance with the invention, with a coloured layer or a reflective layer or a wavelength selective layer prior to deposition of said transparent coating. E.g. the coloured layer or reflective layer or wavelength selective layer could comprise one of gold, titanium nitride, and zirconium carbonitride. A gold layer for example tends to absorb light at the blue end of the spectrum and to reflect light at the red end of the spectrum. Thus if the article is illuminated with white light, for example with daylight, then the blue end of the spectrum is filtered out and absorbed whereas surface plasmon resonance from the particles dispersed in the coating can be selected to generate a red colour. This red colour is then perceived to be more intense or vivid because the (unwanted) blue part of the spectrum of the illuminating light has been absorbed.

Other techniques can also be used in accordance with the invention to enhance the coloured appearance of the article. Thus, a further material can be incorporated into the transparent coating to modify the refractive index thereof.

The use of the methods outlined above lead to articles having a coloured appearance on at least one external surface thereof when illuminated by light, such articles being defined in the claims 16 to 30.

Furthermore, the present invention also relates to a PVD or CVD apparatus adapted to deposit a transparent coating on an article and to deposit within said transparent coating a plurality of dispersed particles, said particles being selected to generate a selectable colour or hue by surface plasmon resonance.

The present invention will now be explained in more detail with reference to examples and to the accompanying drawings in which are shown:

FIG. 1 a diagram to illustrate the mechanisms by which the coloured appearance of an article arises due to interference and surface plasmon resonance,

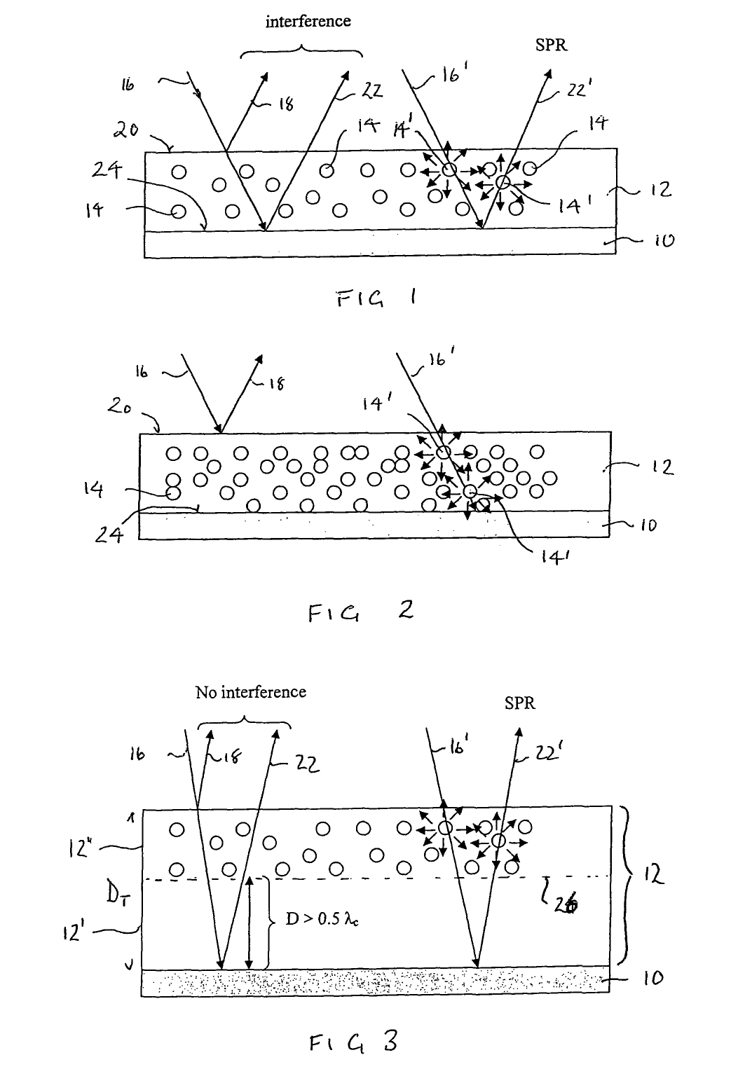

FIG. 2 another diagram relating to an explanation of a possible way of suppressing the colour produced by interference, in accordance with the present invention,

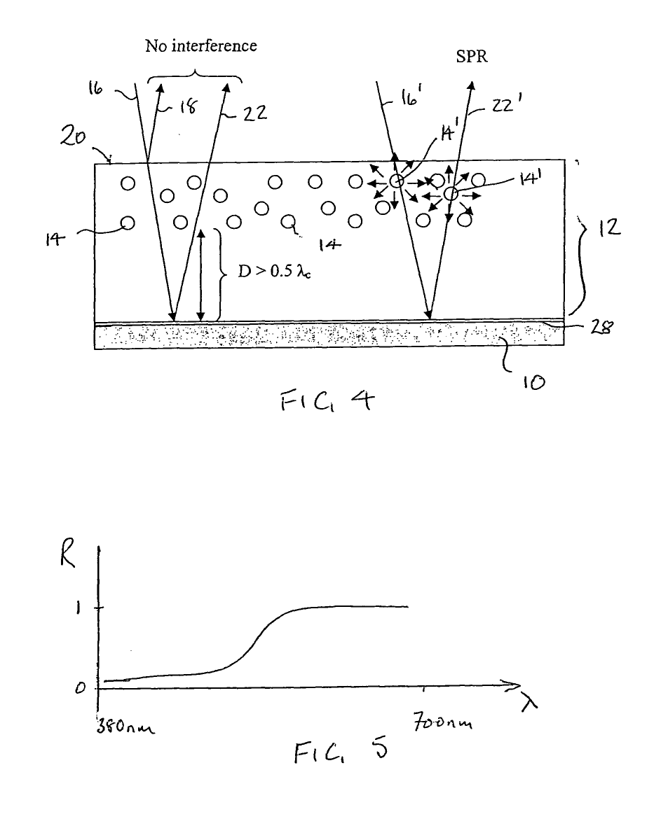

FIG. 3 a diagram showing a preferred way of avoiding the coloured effects due to interference,

FIG. 4 a diagram similar to FIG. 3 but showing the additional use of a reflective coating,

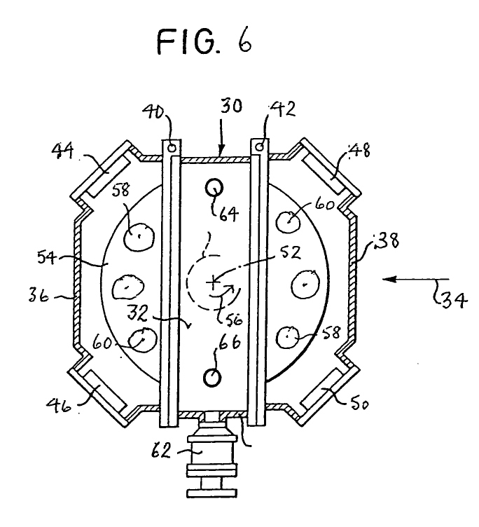

FIG. 5 a graph showing the reflectivity of light by a gold coating and

FIG. 6 a diagram illustrating a plant for the generation of coatings on articles to give these a coloured appearance when illuminated with light.

Turning now to FIG. 1 there can be seen an article or substrate 10 having a transparent coating thereon and dispersed within the transparent coating a plurality of metal particles 14. As shown at the left of the drawing the reference numeral 16 relates to an incident ray of visible light and it can be seen that some of the incident light, ray 18 is reflected at the free surface 20 of the transparent coating 12 and some of the incident light, ray 22, is reflected at the interface 24 between the transparent coating and the substrate. The light of ray 18 and that of ray 22 can interfere and such interference will produce the well known interference colours.

At the right of the drawing another incident ray of light 16′ is shown which is simply reflected from the mirror finish of the substrate and passes back through the thin film, the transparent coating 12, once more before emerging from the transparent coating as ray 22′. In passing through the transparent coating the light 16′ will interact with the conductive metal particles such as 14′ embedded in the dielectric forming the transparent coating and will trigger the generation of surface plasmon resonances with a specific colour or hue (range of wavelengths) typical for the metal involved and dependent on the size of the independent discrete particles 14′. The light resulting from surface plasmon resonance is illustrated by the small arrows radiating in all directions from the two particles 14′ in FIG. 1. Of course the ray 16′ will also trigger a reflection at the surface 20 and the ray 16 could generate surface plasmon resonance if it strikes a particle such as 14. However, these last two possibilities have not been drawn in in FIG. 1 for the sake of clarity.

Turning now to the goal of obtaining uniform colours based on the surface plasmon resonance (SPR) effect in the reflection mode without loss of brightness the following remarks should be made.

Normally SPR based colours can be encountered for instance in old windows in churches. In that case the light is observed in the transmission mode. In contrast the present invention relates to colour generation by SPR in a reflectance mode in a thin film. When a thin film of such a SPR based colour is deposited on a reflecting surface, the colour might be quite different. This is due to the occurrence of two different physical effects.

First of all colour will be produced by the SPR effect as illustrated at the right of the drawing in FIG. 1 Transmitted light is simply reflected from the mirror substrate and passes the thin film once more. For a perfect mirror this would mean that the reflected light will have the same properties as if it had been transmitted through a coating of twice the thickness.

Due to the reflection at the mirror substrate part of the light will interfere with light reflected from the coating surface. This will produce the well known interference colours and will detract from the desired uniform colour or hue resulting from the SPR effect. Due to non-uniformities in the thickness of the transparent coating the interference which occurs represents a loss of colour uniformity, which is again generally undesirable.

One way to prevent the colour produced by interference would be to increase the particle density in the coating. The drawback will be that the brightness of the sample, i.e. the perceived brightness of the article, will most likely decrease significantly, since observed light is now only coming from the scattered light of the particles in the coating plus some contribution from the light reflected at the free surface of the coating. There will also be a tendency for light to be lost in the coating by absorption following scattering at the large number of particles which will again reduce the perceived brightness of the colour.

This situation is illustrated in FIG. 2 in which the same reference numerals are used as in FIG. 1 and have the same significance.

Thus it would be preferable to find another way of avoiding the occurrence of interference colours. One way of doing this is to make certain that the light reflected at the coating surface and the light reflected from the substrate surface are incoherent. One route for achieving this is to start with a thick transparent dielectric layer or coating 12. The thickness of this layer should at least be larger than half the coherence length λ_{c} of the illuminating light that is used. This situation is illustrated in FIG. 3. In FIG. 3 the total thickness D_{T} is greater than the value of λ_{c}/2 this means there can be no interference between the light of ray 18 and that of ray 22 and thus no interference colours. Moreover, the incident light does contribute to the brightness of the perceived appearance of the colour generated by SPR as illustrated at the right of the drawing.

Another way of achieving the same result, i.e. the avoidance of interference colours is to make the coating sufficiently thin that the phase difference introduced by the coating is not sufficient to produce interference. In this connection attention must also be paid to the 180° phase change, i.e. a phase change equal to λ/2 that takes place when light is reflected at an interface between air and a transparent medium, i.e. at the interface 20 in the FIGS. 1 to 4. This means that the thickness of the coating should not introduce a further phase change of 0, λ, 2λ, 3λ, etc, whereas further phase changes of λ/2, 3λ/2, 5λ/2 etc could be considered. A phase change of 0 would arise for a very thin coating with a thickness very much smaller than the wavelength of the light and this must be related to the lowest wavelength of the illuminating light, for example 400 nm. Here a coating thickness of say 50 nm would produce a phase change of ((2×50)/400)360° , i.e. of 90° so that the total phase change is 90°+180°=270°, which would not lead to pronounced interference. A phase change of λ/2 would suggest an ideal coating thickness for blue light of 400/2 =200 nm and this would produce significant enhancement at the blue end of the spectrum and would not be significantly detrimental in the sense of producing interference colours at the red end of the spectrum, because this thickness would correspond to a phase change of (400/700×360)°+180°=386° and this would not lead to serious interference problems.

If a phase change of 3λ/2 is considered, then for blue light at 400 nm the coating thickness would be 3×400/2×2 =300 nm. For red light at 700 nm this same coating thickness would however lead to a phase change of 600/700×360°, i.e. of about 309° and, bearing in mind the 180° phase shift at the air/coating interface 20 this is already a critical value so far as interference at the red end of the spectrum is concerned. Higher values such as 5λ/2 or 7λ/2 are clearly no longer feasible, instead one then has to consider a total coating thicknesses of greater than λ_{c}/2 as explained above.

FIG. 3 also shows that the transparent coating 12 could be made in two layers 12′ and 12″ with the particles only being disposed in the upper layer or stratum 12″ (although they could equally be disposed in the lower layer or stratum 12″). The layers 12′ and 12″ could be of the same transparent dielectric in which case the interface between them shown by the reference numeral 26 is not apparent, because the layers have the same refractive index. The layers could also be deposited continuously with the particles only being deposited in one stratum of the single continuous layer. It is also possible for the particles to be deposited throughout the thick layer 12, but they would then have to have a lower particle density, i.e. number of particles per unit volume, than if they are concentrated in the upper or lower stratum 12″ or 12′ (or in a middle stratum which would also be possible. The layers 12′ and 12″ could also be distinct layers, i.e. of different materials, in which case the different materials should have the same refractive index, because otherwise the interface 26 between the layers would give rise to reflection and possibly also to interference.

Turning now to FIG. 4 there can be seen a diagram very similar to FIG. 3 but with the difference that a reflective layer 28 is provided on the article beneath the transparent coating 12. The point of the reflective layer is to absorb some of the spectrum of the incident light, and to reflect another part of the spectrum of the incident light thus enhancing the desired apparent colour or hue of the article. In this connection reference can be made to FIG. 5 which shows the reflectivity of a gold coating as a function of the optical wavelength. It can be seen that the gold coating absorbs light at the blue end of the spectrum but reflects light at the red end of the spectrum. Thus a gold base layer can enhance colours or hues in the yellow to red end of the spectrum. The same effect can, for example, be achieved with a TiN or ZrCN coating. Other coatings are conceivable which tend to absorb light at the red end of the spectrum but reflect light at the blue end of the spectrum, for example a TiAlₓN_{y} or ZrAlₓN_{y} coating.

An apparatus for the deposition of such coatings will now be explained with reference to FIG. 6. FIG. 6 shows a schematic drawing of a PVD-coating apparatus which is constructed in accordance with the European patent 0 439 561.

In the form shown in FIG. 6 the treatment chamber 30 has a central at least substantially rectangular housing part 32 when viewed from the side, i.e. in the direction of the arrow 34. Two chamber doors 36, 38 are pivotally connected to the left and right hand sides of the central housing part 32 about vertical pivot axles 40, 42, i.e. axles which stand perpendicular to the plane of the drawing. The chamber doors 36 38 are shaped so that the closed housing has an essentially octagonal shape well known per se. Such treatment chambers and the associated sputtering sources are available from the present applicants. When the doors are closed the chamber is closed off at the top and the bottom by roof and base portions of the doors which are not shown in FIG. 6 for the sake of clarity. The doors can be opened to permit access to the interior of the chamber. Each of the chamber doors 36, 38 includes two targets 44, 46 and 48, 50 respectively so there are four targets in total. Two of the targets, e.g. targets 44 and 48 could, for example, consist of aluminium and the other two 46, 50 of gold and silver respectively. All targets can be magnetron sputtering targets and can be operated with the associated power supplies and magnet systems (not shown here but well known per se).

Each target 44, 46, 48, 50 faces towards the axis of rotation 52 of a suitable rotatable table 54 which is rotatable about the axis of rotation in the direction of the arrow 56. The table carries a plurality of workpiece carriers 58 which are each rotatable about their own axes 60 and which each carry a plurality of workpieces (not shown). Rotation of the workpieces in this way, i.e. about the axes of rotation 60 of the workpiece carriers 58 and about the axis of rotation 52 of the table 54, means that all surfaces of the workpieces can be exposed to the coating flux from the targets and the workpieces can be substantially uniformly coated. It is also possible to use more complicated rotations if necessary or to restrict the movement of the workpieces, for example to a simple rotation about the axis 52 of the table 54 so that only one surface or surface region of the workpiece is coated.

The reference numeral 62 refers to a high performance vacuum pump which serves in known manner to generate the necessary vacuum in the treatment chamber. The reference numeral 64 refers to a supply point for an inert gas, for example argon, while the reference numeral 66 refers to a supply point for a reactive gas such as oxygen.

The plant can be operated as follows:

First of all the atmosphere in the chamber is evacuated and replaced by argon. This is done by in known manner by operation of the vacuum pump 62 and simultaneous supply of argon to flush the originally present residual air from the vacuum chamber. The PVD plant is then operated in a cleaning and etching mode well known per se by operation of the magnetrons with the aluminium targets and using the argon atmosphere to clean and etch the surfaces of the workpieces rather than to coat them.

This etching process also leads to a high quality reflective surface at the workpieces.

The apparatus is then changed over to a reactive sputtering mode using the aluminium targets to generate an aluminium vapour and simultaneously supplying oxygen to react with the aluminium vapour and deposit a transparent Al₂O₃ coating on the substrate. This is again well known per se. Assuming a coating in accordance with FIG. 3 is to be deposited the above described sputtering mode is used to first deposit a layer of aluminium oxide without any included gold or silver particles, i.e. the layer 12′ in FIG. 3. Thereafter one or both of the gold or silver targets, which were hitherto inactive are switched on to deposit small particles of gold or silver in the deposited aluminium oxide coating of layer 12″. The deposition of the small particles and the transparent dielectric can be performed either simultaneously or sequentially.

The gold and/or silver targets are operated in such a way, i.e. with operating parameters such as bias voltage, current density and magnetic field, that small agglomerations of gold and/or silver atoms form in the coating, i.e. the desired discrete particles of these metals. The coating is continued until the desired thickness of the coating and the desired particle density of the metal or metals incorporated in the coating have been reached. The workpieces can now be removed from the chamber by opening the chamber doors and will exhibit the required coloured appearance determined by the precise metal or combination of metals selected and the particle sizes of the metal or combination of metals as incorporated in the coating.

It should be noted that with gold and silver there is no significant danger that gold or silver oxides will be deposited instead of the pure metals despite the presence of oxygen in the vacuum chamber. The reason is that the oxides of gold and silver are unstable and revert to the pure metal at temperatures of about 150° C. and 250° C. respectively. Since the PVD apparatus is or can be operated at higher temperatures the formation of gold or silver oxides is not a problem. The presence of a small quantity of such oxides in the coating is tolerable and large quantities are not in any case expected because of the kinematics of the process and the fact that the oxygen only forms part of the vacuum atmosphere of the chamber.

Platinum also forms an oxide which breaks down at elevated temperature, albeit at a higher temperature than silver. However, the kinematics of the process suggest that a problem with the formation of platinum oxide also does not exist, particularly since the oxygen preferentially reacts with the aluminium. Should a problem with the formation of an oxide exist (or other compound of the metal if a different reactive gas is used) then the coating can be deposited in alternating layers of transparent coating and particles of the metal, with the particles of metal only being deposited when the reactive gas has been flushed from the chamber and replaced by an inert gas. Alternatively a gas frame can be used to supply inert gas to the space between the front face of the target and the surface of the work-pieces as they pass in front of the target thus suppressing the formation of metal oxides or other compounds thereof.

If a reflective layer such as 28 in FIG. 4 is to be deposited then this can be done using the gold or silver target operated in a non-reactive mode using an inert gas in the vacuum chamber prior to starting the deposition of the transparent coating.

The step of depositing the transparent coating can also be done by a CVD (chemical vapour deposition process) instead of by a PVD (physical vapour deposition) as described above. Such a CVD process would normally also be carried out in a vacuum chamber containing a plasma generating device or devices for plasma enhanced chemical vapour deposition. The chamber can also include one or more magnetron sources for the deposition of the metals if these cannot be deposited by a CVD process.

The transparent coating can be selected from the group comprising SiO, SiCₓO_{y}, SiNₓ, SiOₓN_{y}, SiOₓC_{y}N_{z}, C, Al₂O₃, TiO₂, Cr₂O₃, SiOₓ, ZrOₓ and combinations thereof, many of which can be generated by a CVD process or by a sputtering or reactive sputtering process.

The particles used can consist of at least one of gold, silver, copper, platinum and other metals such as titanium or chromium.

1. A method of giving an article a coloured appearance on at least one external surface thereof when illuminated by light, the method comprising the following steps:
depositing a transparent coating on said external surface and
incorporating a plurality of dispersed particles within the transparent coating, said particles being selected to generate a selectable colour or hue by surface plasmon resonance.

2. A method in accordance with claim 1 wherein said step of depositing a transparent coating comprises the use of a PVD (physical vapour deposition) process or of a CVD (chemical vapour deposition process).

3. A method in accordance with either one of the preceding claims wherein the transparent coating is selected from the group comprising SiO, SiCₓO_{y}, SiNₓ, SiOₓN_{y}, SiOₓC_{y}N_{z}, C, Al₂O₃, TiO₂, Cr₂O₃, SiOₓ, ZrOₓ and combinations thereof.

4. A method in accordance with any one of the preceding claims wherein said particles consist of at least one of gold, silver, copper, platinum and other metals.

5. A method in accordance with claim 4 wherein said particles are incorporated in said coating using a PVD or CVD process.

6. A method in accordance with any one of the preceding claims wherein the thickness of said transparent coating is selected to suppress interference effects arising from interference of the illuminating light reflected at the free surface of said coating with illuminating light reflected at an interface of the coating with the article or with another layer of the coating.

7. A method in accordance with any one of the preceding claims wherein said transparent coating is given a thickness significantly smaller than the wavelength of the illuminating light.

8. A method in accordance with any one of the preceding claims 1 to 6 wherein said transparent coating is given a thickness greater than half the coherence length λ_{c} of the illuminating light.

9. A method in accordance with any one of the claims 1 to 6 wherein said transparent coating is given a thickness having a nominal value in the range 80 to 120 nm especially of around 100 nm to enhance a blue colour by constructive interference (depending also on the refractive index of the transparent dielectric).

10. A method in accordance with any one of the preceding claims wherein the particles are dispersed in said transparent coating substantially throughout the transparent coating, in particular with a substantially uniform density.

11. A method in accordance with any one of the preceding claims 1 to 9 wherein said particles are dispersed in said transparent coating in a stratum thereof.

12. A method in accordance with claim 11 wherein said transparent coating comprises at least first and second layers and said stratum comprises one of said layers, said first and second layers preferably having identical refractive indices.

13. A method in accordance with any one of the preceding claims wherein the article is coated with a coloured layer or a reflective layer or a wavelength selective layer prior to deposition of said transparent coating.

14. A method in accordance with claim 13 wherein said coloured layer, reflective layer or wavelength selective layer comprises one of gold, titanium nitride, titanium carbonnitride, zirconium nitride, zirconium carbonitride, or any other metal, alloy, or metalceramic.

15. A method in accordance with any one of the preceding claims and including the step of incorporating a further material into the transparent coating to modify the refractive index thereof.

16. An article having a coloured appearance on at least one external surface thereof when illuminated by light, the coloured appearance being generated by a transparent coating deposited on said external surface and a plurality of dispersed particles within the transparent coating, said particles being selected to generate a selectable colour or hue by surface plasmon resonance.

17. An article in accordance with claim 16 wherein said transparent coating is a PVD (physical vapour deposition) coating or a CVD (chemical vapour deposition process) coating.

18. An article in accordance with either one of the preceding claims 16 or 17 wherein the transparent coating comprises one SiO, SiCₓO_{y}, SiNₓ, SiOₓN_{y}, SiOₓC_{y}N_{z}, C, Al₂O₃, TiO₂, Cr₂O₃, SiOₓ, ZrOₓ and combinations thereof.

19. An article in accordance with any one of the preceding claims 16 to 18 wherein said particles consist of at least one of gold, silver, copper, platinum and other metals.

20. An article in accordance with claim 19 wherein said particles are incorporated in said coating using a PVD or CVD process.

21. An article in accordance with any one of the preceding claims 16 to 20 wherein the thickness of said transparent coating is selected to suppress interference effects arising from interference of the illuminating light reflected at the free surface of said coating with illuminating light reflected at an interface of the coating with the article or with another layer of the coating.

22. An article in accordance with any one of the preceding claims 16 to 21 wherein said transparent coating is given a thickness significantly smaller than the wavelength of the illuminating light.

23. An article in accordance with any one of the preceding claims 16 to 21 wherein said transparent coating is given a thickness greater than half the coherence length λ_{c} of the illuminating light.

24. An article in accordance with any one of the claims 16 to 21 wherein said transparent coating is given a thickness having a nominal value in the range 80 to 120 nm especially of around 100 nm to enhance a blue colour by constructive interference (depending also on the refractive index of the transparent dielectric).

25. An article in accordance with any one of the preceding claims 16 to 24 wherein the particles are dispersed in said transparent coating substantially throughout the transparent coating, in particular with a substantially uniform density.

26. An article in accordance with any one of the preceding claims 16 to 24 wherein said particles are dispersed in said transparent coating in a stratum thereof.

27. An article in accordance with claim 26 wherein said transparent coating comprises at least first and second layers and said stratum comprises one of said layers, said first and second layers preferably having identical refractive indices.

28. An article in accordance with any one of the preceding claims 16 to 27 wherein the article is coated with a coloured layer or a reflective layer or a wavelength selective layer prior to deposition of said transparent coating.

29. An article in accordance with claim 28 wherein said coloured layer, or reflective layer or wavelength selective layer comprises one of gold, titanium nitride, titanium carbonnitride, zirconium nitride, zirconium carbonitride, or any other metal, alloy, or metalceramic.

30. An article in accordance with any one of the preceding claims said transparent coating having a further material homogeneously dispersed therein to modify the refractive index thereof.

31. An apparatus capable of PVD and/or CVD processes adapted to deposit a transparent coating on an article and to deposit within said transparent coating a plurality of dispersed particles, said particles being selected to generate a selectable colour or hue by surface plasmon resonance.
